(19) United States
(12) Patent Application Publication
(10) Pub. No.: US 2011/0062772 A1
(43) Pub. Date: Mar. 17, 2011

(54) BEARING RETAINER FOR HEAVY-DUTY VEHICLE WHEEL END ASSEMBLY

(75) Inventor: Jay D. White, Massillon, OH (US)

(73) Assignee: HENDRICKSON USA, L.L.C., Itasca, IL (US)

(21) Appl. No.: 12/880,757

(22) Filed: Sep. 13, 2010

Related U.S. Application Data
(60) Provisional application No. 61/242,196, filed on Sep. 14, 2009.

(51) Int. Cl. B60B 27/02; B23P 11/02

(52) U.S. Cl. 301/110; 29/446; 29/525.08

(57) ABSTRACT

A wheel end assembly for a heavy-duty vehicle includes an inboard bearing that is immovably mounted on an axle spindle, an outboard bearing that is immovably mounted on the axle spindle outboardly of the inboard bearing, and a wheel hub that is rotatably mounted on the bearings. A bearing retainer for the wheel end assembly includes a circumferentially-extending groove that is formed in an inner surface of the wheel hub adjacent an outboard surface of the wheel hub, and a retainer ring that is received in the groove. The retainer ring contacts a radially outward edge of a roller of a cone of the outboard bearing when the roller is at its minimum projected diameter in order to retain the relative position of the outboard bearing cone in the wheel hub during servicing of components of the wheel end assembly.

### CROSS-REFERENCE TO RELATED APPLICATIONS

This application claims the benefit of U.S. Provisional Patent Application Ser. No. 61/242,196, which was filed on Sep. 14, 2009.

### BACKGROUND OF THE INVENTION

1. Technical Field

The invention relates to vehicle wheel end assemblies, and in particular to wheel end assemblies for heavy-duty vehicles, such as tractor-trailers. More particularly, the invention is directed to a bearing retainer for a heavy-duty wheel end assembly, which retains the relative position of the cone of the outboard bearing in a hub during servicing of a brake rotor or components of the wheel end assembly, thereby minimizing potential problems encountered during the disassembly and/or reassembly of the wheel end assembly, and improving the accuracy and efficiency of the servicing operation.

2. Background Art

For many years, the heavy-duty vehicle industry has utilized wheel end assemblies which are mounted on each end of one or more non-drive axles. Each wheel end assembly typically includes a hub rotatably mounted on a bearing assembly that in turn is immovably mounted on the outboard end of the axle, commonly known as an axle spindle. The bearing assembly includes an inboard bearing and an outboard bearing, which may be separated by a bearing spacer. An axle spindle nut assembly secures the bearing assembly on the axle spindle by threadably engaging threads that are cut into the outer diameter of the outboard end of the axle spindle. In addition to retaining the position of the bearings and any spacer, the axle spindle nut assembly may be used to provide a clamp force to compress the bearings, and any bearing spacer, to a predetermined amount, as will be explained in greater detail below.

As is well known to those skilled in the art, for normal operation of the wheel end assembly to occur, the bearing assembly and surrounding components must be lubricated with grease or oil. Therefore, the wheel end assembly also must be sealed to prevent leakage of the lubricant, and also to prevent contaminants from entering the assembly, both of which could be detrimental to its performance. More specifically, a hubcap is mounted on an outboard end of the hub adjacent to and outboard from the axle spindle nut assembly, and a main seal is rotatably mounted on an inboard end of the hub in abutment with the axle spindle, resulting in a closed or sealed wheel end assembly.

While most wheel end assemblies include these general features, the design and arrangement of the hub, bearing assembly, any bearing spacer, axle spindle nut assembly, hubcap, main seal, and other components, vary according to the specific vehicle design and its anticipated uses. Moreover, the design and construction of prior art wheel end assemblies exhibit certain disadvantages in properly retaining the relative position of the outboard bearing on the hub during disassembly and/or reassembly of the wheel end assembly.

More particularly, as mentioned above, the wheel end assembly is closed or sealed to prevent leakage of lubricant, and to reduce the possibility that contaminants may be introduced into the assembly, as the contaminants may undesirably reduce the life of the bearings and/or other components of the assembly. By way of background, each one of the inboard and outboard bearings includes a cup and a cone, and each cone further includes an integral sub-assembly of multiple rollers, an inner ring that supports the rollers, and a cage which retains the position of each roller on the inner ring. During the initial assembly operation of the wheel end assembly, the cup of the inboard bearing is pressed into the inboard end of the hub, and the cup of the outboard bearing is pressed into the outboard end of the hub. The cone of the inboard bearing then is inserted into the inboard end of the hub, and the main seal is mounted on the inboard end of the hub, which retains the general position of the cone of the inboard bearing. The cone of the outboard bearing is inserted into the outboard end of the hub, and the hub, containing the bearings and main seal, is mounted on the axle spindle. The spindle nut assembly then is installed on the axle spindle to secure the bearing assembly and the hub on the axle spindle.

Over the life of the vehicle, it is necessary to service a brake rotor or other components that may be attached to the wheel end assembly, or components of the wheel end assembly itself. During the servicing of such components, the hub of the wheel end assembly must be removed from the axle spindle in a shop environment. In this disassembly operation, the spindle nut assembly is removed from the axle spindle, and a technician then typically pulls the hub, together with the bearings and main seal, as a unit, off of the axle spindle. During the disassembly process, the engagement of the main seal on the inboard end of the hub typically retains the general position of the cone of the inboard bearing. However, in the prior art, once the spindle nut assembly is removed, the cone of the outboard bearing lacks positive mechanical engagement with the outboard end of the hub.

As a result, the cone of the outboard bearing may slide out of the outboard end of the hub during the disassembly process. If the outboard bearing slides out of the hub, it may become damaged, and/or the remainder of the wheel end assembly may be exposed to contaminants, either one of which undesirably can reduce the life of the bearings. In addition, if the cone of the outboard bearing slides out of the hub during the disassembly process, or alternatively during reassembly of the wheel end assembly, the outboard end of the hub may undesirably shift or tip radially relative to the axle spindle, which may crimp or kink the main seal on the inboard end of the hub, thereby undesirably causing possible damage to the main seal.

Moreover, during reassembly of the wheel end assembly, it is desirable for the outboard bearing cone to be retained in a proper position before the spindle nut assembly is installed onto the axle spindle. More particularly, when the outboard bearing cone is retained in a proper position, the technician is able to focus on installation of the spindle nut assembly onto the axle spindle, rather than on the position of the outboard bearing cone. Such focus on the installation of the spindle nut assembly is important, as the installation of the spindle nut assembly typically is a precise operation.

More specifically, installation of the spindle nut assembly onto the axle spindle creates a clamp force on the bearings. For example, when a bearing spacer is employed, tightening of the spindle nut assembly provides a force on the cones of the bearings and the spacer between them, which compresses or pre-loads the bearings. Alternatively, when a bearing spacer is not employed, the position of the spindle nut assembly typically is used to create either a light pre-load on the bearings, or a slight amount of end play to avoid over-compression of the bearings. If the position of the spindle nut assembly does not create a sufficient clamp force on the bearing cones and any spacer, there may be excessive end play of the bearings, which in turn creates excessive axial end play of the wheel end assembly relative to the axle spindle, thereby allowing undesirable movement of the main seal that may reduce the life of the main seal and the bearings. If the position of the spindle nut assembly creates a clamp force on the bearing cones and any spacer that is too high, the bearings may effectively be over-compressed, interfering with their rotation and causing them to possibly wear out prematurely. As a result, optimum positioning of the spindle nut assembly to create an optimum clamp force on the bearing cones and any spacer is important.

Therefore, movement of the cone of the outboard bearing out of the hub during disassembly or reassembly of the wheel end assembly may result in contamination of the wheel end assembly, damage to components, and/or potential improper installation of the spindle nut assembly, all of which result in an undesirable increase in the time and cost associated with the servicing of the wheel end assembly.

In the prior art, retainers have been employed. However, these retainers typically have been an integral part of a certain type of spindle nut assembly, which is not readily separable from the hub. More particularly, when a brake rotor or components of the wheel end assembly are to be serviced, certain prior art spindle nut assemblies are designed to be loosened on the axle spindle, and then removed from the axle spindle together with the hub. Some of these spindle nut assemblies include retainers, which possess disadvantages associated with reassembly of the wheel end assembly. For example, these retainers allow the cone of the outboard bearing to move somewhat, so that a gap between the bearing cup and cone is created. Because the retainer is part of the spindle nut assembly, during reassembly, the spindle nut assembly prevents a technician from positioning the outboard bearing cone closer to the bearing cup to close the gap between them. Rather, tightening of the spindle nut assembly is used to move the bearing cone toward the bearing cup, which creates the possibility that the outboard bearing cone may be out of position and/or not properly seated when the spindle nut assembly is tightened, thereby binding and thus damaging the bearing.

As a result, there is a need in the art for an apparatus that retains the relative position of the outboard bearing, and particularly the cone of the outboard bearing, in a hub during servicing of a brake rotor or of components of the wheel end assembly, thereby minimizing the possibility of contamination of the wheel end assembly, damage to components of the wheel end assembly, and potential improper installation of the spindle nut assembly, all of which improves the accuracy and efficiency of the servicing operation. There is also a need for the bearing retainer to be separate from the spindle nut assembly to provide retention of the relative position of the outboard bearing, and particularly the cone of the outboard bearing, in the hub when the spindle nut assembly is not installed and/or not tightened, and/or to enable a technician to properly position the outboard bearing cone prior to tightening of the spindle nut assembly. The present invention satisfies these needs, as will be described below.

### BRIEF SUMMARY OF THE INVENTION

An objective of the present invention is to provide a bearing retainer for heavy-duty vehicle wheel end assembly that retains the relative position of the outboard bearing, and particularly the cone of the outboard bearing, in a hub during servicing of a brake rotor or of components of the wheel end assembly.

Another objective of the present invention is to provide a bearing retainer for heavy-duty vehicle wheel end assembly that minimizes the possibility of contamination of the wheel end assembly, damage to components of the wheel end assembly, and potential improper installation of the spindle nut assembly.

Yet another objective of the present invention is to provide a bearing retainer for heavy-duty vehicle wheel end assembly that is separate from the spindle nut assembly to provide retention of the relative position of the outboard bearing, and particularly the cone of the outboard bearing, in the hub when the spindle nut assembly is not installed and/or not tightened.

Still another objective of the present invention is to provide a bearing retainer for heavy-duty vehicle wheel end assembly that is separate from the spindle nut assembly to enable a technician to properly position the outboard bearing cone prior to tightening of the spindle nut assembly.

These objectives and others are obtained by the bearing retainer for a heavy-duty vehicle wheel end assembly of the present invention. In an exemplary embodiment of the invention, the wheel end assembly includes an inboard tapered roller bearing that is immovably mounted on an axle spindle, an outboard tapered roller bearing that is immovably mounted on the axle spindle outboardly of the inboard bearing, and a wheel hub that is rotatably mounted on the inboard and outboard bearings. The bearing retainer includes a circumferentially-extending groove formed in an inner surface of the wheel hub adjacent an outboard surface of the wheel hub, and a retainer ring that is received in the groove. The retainer ring contacts a radially outward edge of a roller of a cone of the outboard bearing when the roller is at its minimum projected diameter, and the retainer ring is formed with an inner diameter that is larger than an outer diameter of a spindle nut of an axle spindle nut assembly. The retainer ring retains the relative position of the outboard bearing cone in the wheel hub during servicing of components of the wheel end assembly.

These objectives and others are also obtained by the method of assembling a heavy-duty vehicle wheel end assembly including a bearing retainer of the present invention. In an exemplary embodiment of the invention, the method includes the steps of providing an inboard tapered roller bearing, providing a wheel hub that includes a circumferentially-extending groove formed in an inner surface of the wheel hub adjacent an outboard surface of the wheel hub, and pressing a cup of the tapered inboard roller bearing into an inboard end of the wheel hub. An outboard tapered roller bearing is provided, and a cup of the tapered outboard roller bearing is pressed into an outboard end of the wheel hub. A cone of the inboard bearing is inserted into the inboard end of the wheel hub, and a cone of the outboard bearing is inserted into the outboard end of the wheel hub. A retainer ring is provided, the retainer ring is compressed to clear the inner surface of the wheel hub, and the retainer ring is inserted into an inner diameter of the wheel hub. The compression of the retainer ring is released when the retainer ring is in alignment with the groove, and the retainer ring seats in the groove, contacting a radially outward edge of a roller of the outboard bearing cone when the roller is at its minimum projected diameter. The wheel hub is mounted on an axle spindle, and the retainer ring retains the relative position of the outboard bearing cone in the wheel hub during servicing of components of the wheel end assembly.

### BRIEF DESCRIPTION OF THE SEVERAL VIEWS OF THE DRAWINGS

The preferred embodiments of the present invention, illustrative of the best mode in which Applicants have contemplated applying the principles, are set forth in the following description and are shown in the drawings, and are particularly and distinctly pointed out and set forth in the appended claims.

FIG. 1 is a fragmentary cross-sectional perspective view of an axle spindle and wheel end assembly of the prior art, shown with a spindle nut assembly and a hubcap installed on the wheel end assembly;

FIG. 2 is a fragmentary longitudinal cross-sectional view of the axle spindle and wheel end assembly shown in FIG. 1, but without the hubcap on the wheel end assembly;

FIG. 3 is a fragmentary cross-sectional view of an axle spindle and wheel end assembly including an exemplary embodiment of the bearing retainer of the present invention, shown with a hubcap and brake rotor installed on the wheel end assembly;

FIG. 4 is a reduced-size, exploded perspective view of the wheel end assembly, hubcap and brake rotor shown in FIG. 3, but with the axle spindle removed; and

FIG. 5 is an enlarged, fragmentary cross-sectional view of a portion of the axle spindle and wheel end assembly shown in FIG. 3.

Similar numerals refer to similar parts throughout the drawings.

### DETAILED DESCRIPTION OF THE INVENTION

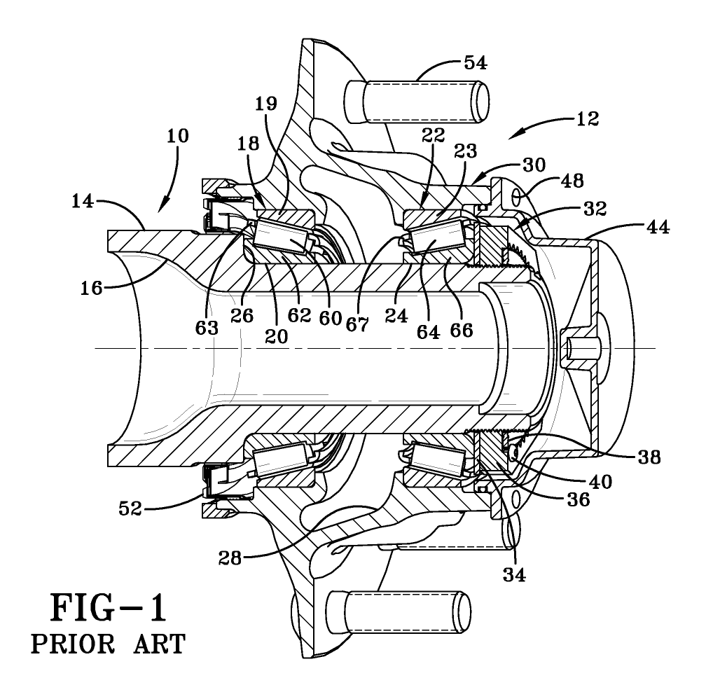

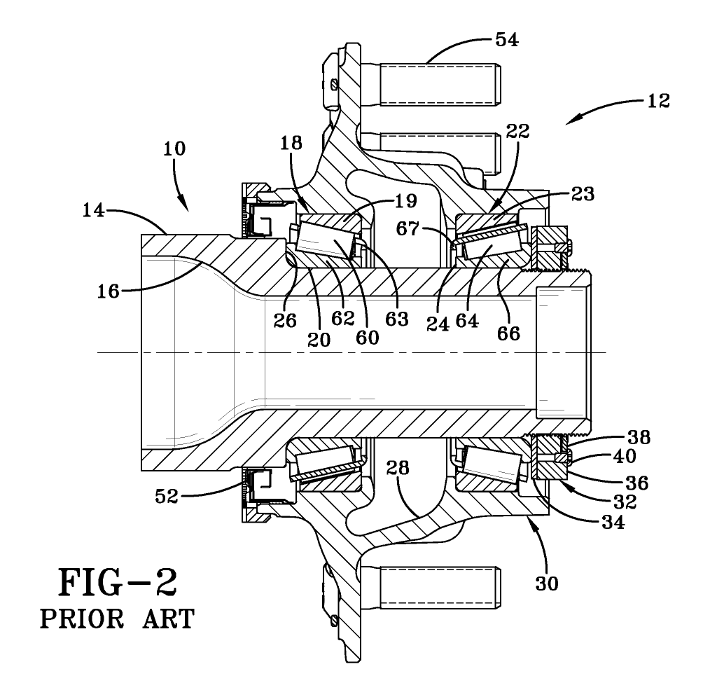

In order to better understand the bearing retainer of the present invention and the environment in which it operates, a prior art axle spindle and wheel end assembly for a heavy-duty vehicle is shown in FIGS. 1 and 2 and now will be described. An axle 10 depends from and extends transversely across the trailer of a heavy-duty tractor-trailer (not shown). A typical heavy-duty tractor-trailer includes one or more non-drive axles 10 suspended from the trailer, with each of the axles having a wheel end assembly 12 mounted on each end of the axle. Since each of the ends of axle 10 and its associated wheel end assembly 12 are generally identical, only one axle end and wheel end assembly 12 will be described herein. Axle 10 includes a central tube (not shown), and an axle spindle 14 is integrally connected by any suitable means, such as welding, to each end of the central tube. The axle central tube generally is tubular-shaped and is formed with an internal cavity (not shown). Axle spindle 14 is formed with a corresponding internal cavity 16.

Wheel end assembly 12 includes a bearing assembly having an inboard bearing 18 and an outboard bearing 22. Inboard bearing 18 and outboard bearing 22 are heavy-duty tapered roller bearings. More particularly, inboard bearing 18 includes a cup 19 and a cone 20, and the cone further includes a plurality of rollers 60, a race or radially inner ring 62 that supports the rollers, and a cage 63, which retains the position of each roller on the inner ring. Outboard bearing 22 includes a cup 23 and a cone 24, and the cone further includes a plurality of rollers 64, a race or radially inner ring 66 that supports the rollers, and a cage 67, which retains the position of each roller on the inner ring. Cup 19 of inboard bearing 18 is pressed into an inboard end of a hub 30. Cone 20 of inboard bearing 18 is mounted on the outer diameter of axle spindle 14 and has its inboard surface in abutment with a shoulder 26 formed in the axle spindle. Cup 23 of outboard bearing 22 is pressed into an outboard end of hub 30. Cone 24 of outboard bearing 22 is mounted on axle spindle 14 near the outboard end of the axle spindle. A cavity 28 is defined by inboard and outboard bearings 18, 22, axle spindle 14 and hub 30. A bearing spacer (not shown) optionally is disposed between bearings 18, 22 in cavity 28 to conveniently maintain proper spacing between the bearings.

Hub 30 is rotatably mounted on inboard and outboard bearings 18, 22 in a manner known to those skilled in the art. More particularly, the initial assembly operation for wheel end assembly 12 typically includes pressing inboard bearing cup 19 into the inboard end of hub 30, and pressing outboard bearing cup 23 into the outboard end of the hub. Inboard bearing cone 20 then is inserted into the inboard end of hub 30, and a main seal 52 is mounted on the inboard end of the hub. Outboard bearing cone 24 is inserted into the outboard end of hub 30, and the hub with bearings 18, 22 and main seal 52 is mounted on axle spindle 14. An axle spindle nut assembly 32 is installed on axle spindle 14 to secure bearings 18, 22 and hub 30 on the axle spindle.

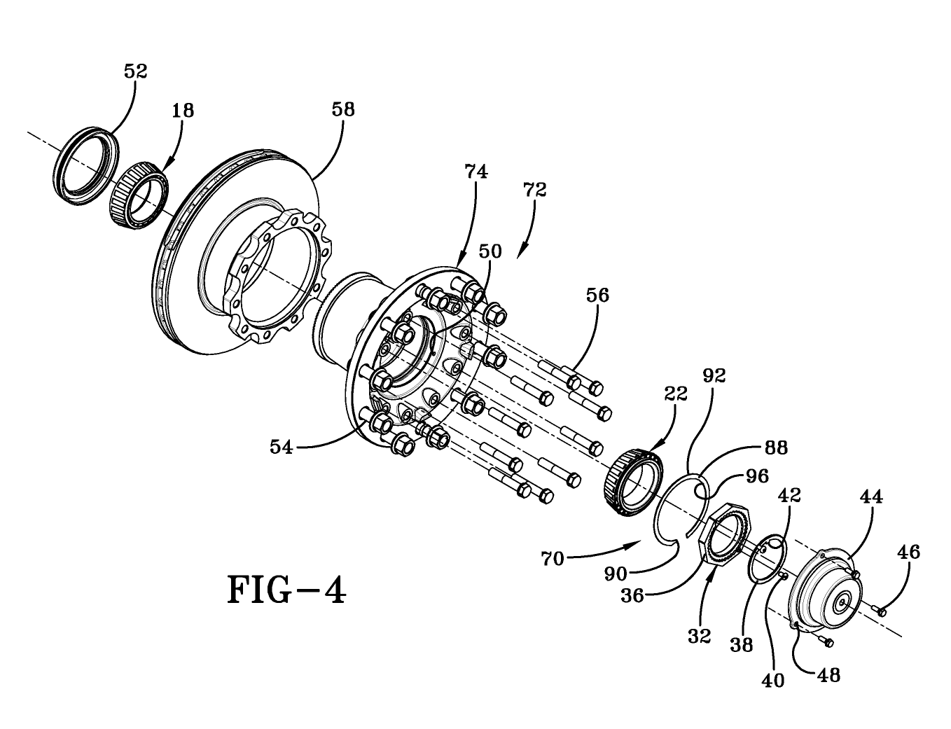

Axle spindle nut assembly 32 includes an optional inner washer 34, an axle spindle nut 36, an outer washer 38, and at least one screw 40. Axle spindle nut 36, washers 34, 38 and screw 40 cooperate to secure bearings 18, 22 and hub 30 in place, and to provide the proper clamp force on bearing cones 20, 24 and any spacer. More particularly, nut 36 threadably engages axle spindle 14 and abuts the outboard end of outboard bearing 22 when inner washer 34 is not used. When inner washer 34 is used, nut 36 contacts the inner washer, and the inner washer in turn contacts outboard bearing 22. Nut 36 receives outer washer 38 in an assembled state, and the outer washer is formed with a tab 42 (FIG. 4) on its inner periphery, which engages a keyway (not shown) formed in axle spindle 14 to prevent the outer washer from rotating once it is installed on the axle spindle. Teeth formed on each one of nut 36 and outer washer 38 enable the nut and washer to positively mechanically engage and interlock with one another, thereby preventing the nut from undesirably rotating after installation on axle spindle 14.

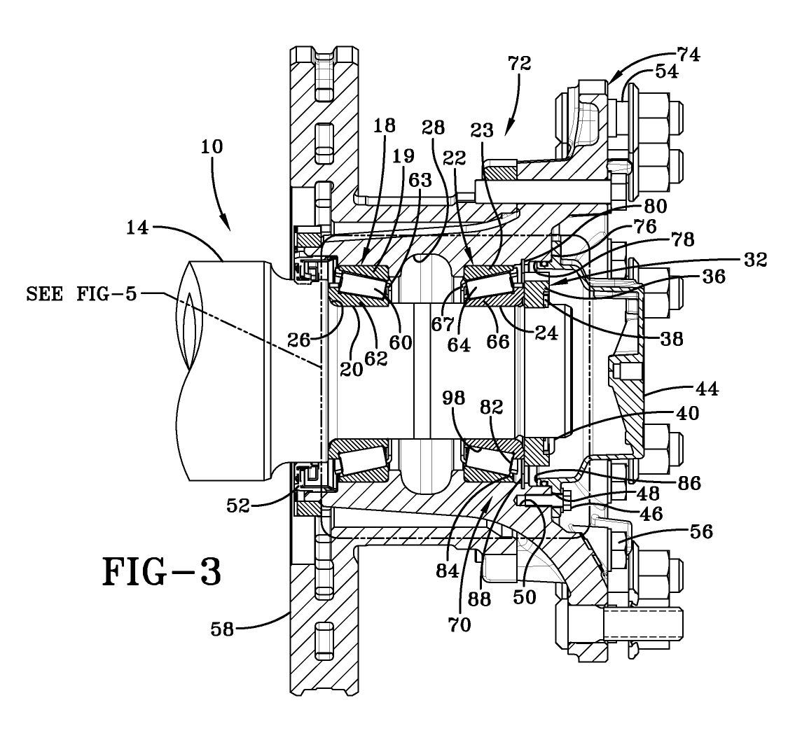

A hubcap 44 is mounted on the outboard end of hub 30 by a plurality of bolts 46 (FIG. 3) that each pass through a respective one of a plurality of openings 48 (FIG. 3) formed in the hubcap, and threadably engage a respective one of a plurality of aligned threaded openings 50 (FIG. 3) formed in the hub. In this manner, hubcap 44 closes the outboard end of wheel end assembly 12. As described above, main continuous seal 52, which is rotatably mounted on the inboard end of wheel end assembly 12, closes the inboard end of the assembly. More particularly, seal 52 is mounted on wheel end assembly 12 in a suitable manner and radially bridges hub 30 and axle spindle 14 to seal cavity 28. In order to maintain proper lubrication and operation of inboard and outboard bearings 18, 22, a suitable amount of lubricant (not shown) is introduced into cavity 28. A plurality of interference-fit studs 54 are used to mount a brake drum, tire rim and tire (not shown) on wheel end assembly 12, and bolts 56 (FIG. 3) are used to mount a brake rotor 58 to hub 30 (FIG. 3).

As described above, during servicing of brake rotor 58 or other components that may be attached to wheel end assembly 12, or servicing of components of the wheel end assembly itself, hub 30 must be removed from axle spindle 14 in a shop environment. The disassembly operation includes removing spindle nut assembly 32 from axle spindle 14, and pulling hub 30, together with bearings 18, 22 and main seal 52 as a unit, off of the axle spindle. During the disassembly process, outboard bearing cone 24 may slide out of the outboard end of hub 30, which may result in damage to the outboard bearing cone, and/or exposure of the remainder of wheel end assembly 12 to contaminants, either one of which undesirably reduces the life of bearings 18, 22. In addition, the outboard end of hub 30 may undesirably shift or tip radially relative to axle spindle 14, which may crimp or kink main seal 52, thereby potentially damaging the main seal. Moreover, during reassembly of wheel end assembly 12, it is desirable for outboard bearing cone 24 to be retained in a proper position before spindle nut assembly 32 is installed onto axle spindle 14, so that the technician is able to focus on proper installation of the spindle nut assembly.

Therefore, movement of outboard bearing cone 24 out of the outboard end of hub 30 during disassembly or reassembly of wheel end assembly 12 may result in contamination of the wheel end assembly, damage to components, and/or potential improper installation of spindle nut assembly 32, all of which result in an undesirable increase in the time and cost associated with the servicing of the wheel end assembly. In addition, retainers of the prior art have been an integral part of certain types of spindle nut assemblies that are designed to be loosened on axle spindle 14 and then removed from the axle spindle together with the hub, which prevents proper positioning of outboard bearing cone 24 before the spindle nut assembly is tightened, thereby potentially binding and damaging the bearing.

As a result, there is a need in the art for an apparatus that retains the relative position of outboard bearing 22, and particularly cone 24 of the outboard bearing, in hub 30 during servicing of brake rotor 58 or of components of wheel end assembly 12, thereby minimizing the possibility of contamination of the wheel end assembly, damage to components of the wheel end assembly, and potential improper installation of spindle nut assembly 32, all of which improves the accuracy and efficiency of the servicing operation. There is also a need for the apparatus to be separate from spindle nut assembly 32 to provide retention of the relative position of outboard bearing 22, and particularly cone 24 of the outboard bearing, in hub 30 when the spindle nut assembly is not installed and/or tightened, and/or to enable a technician to properly position the outboard bearing cone prior to tightening of the spindle nut assembly. The present invention satisfies these needs, as now will be described.

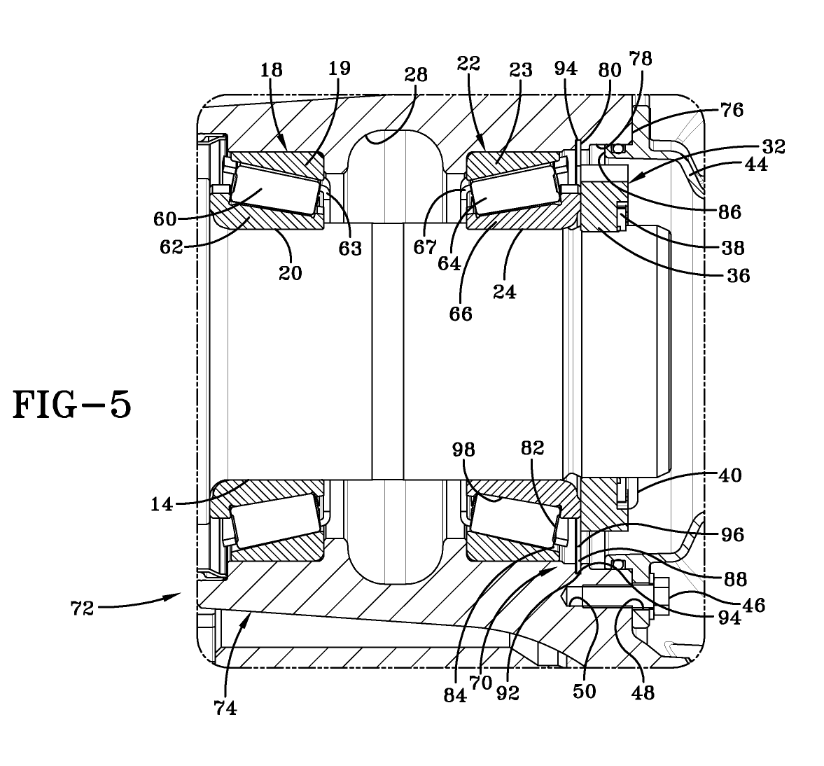

Turning now to FIGS. 3-5, an exemplary embodiment of the bearing retainer of the present invention is shown and is indicated generally at 70. Bearing retainer 70 finds application in conjunction with prior art axle 10, including axle spindle 14, and in accordance with an important feature of the present invention, is incorporated into a wheel end assembly 72. Wheel end assembly 72 is improved over prior art wheel end assembly 12, which lacks a bearing retainer. Wheel end assembly 72 is also improved over prior art wheel end assemblies that include a retainer as a part of an axle spindle nut assembly which is removed from axle spindle 14 together with a hub, as bearing retainer 70 is separate from axle spindle nut assembly 32, which in turn is separate from a hub, as will be described below. Certain aspects of the general construction and operation of wheel end assembly 72 are similar to prior art wheel end assembly 12 described above. Therefore, for the purposes of clarity and convenience, only the differences between wheel end assembly 72, which incorporates bearing retainer 70 of the present invention, and prior art wheel end assembly 12 will be described in detail below.

Wheel end assembly 72 includes a hub 74, which is rotatably mounted on inboard bearing 18 and outboard bearing 22 as described above. Hub 74 includes an inner surface 78 adjacent a hub outboard surface 76. Formed in inner surface 78 proximate outboard surface 76 is a circumferentially-extending groove 80. More particularly, the location of groove 80 in hub inner surface 78 is outboard of an outboard surface 82 of roller 64 of outboard bearing cone 24, and inboard of an inboard-most surface 86 of hubcap 44. This location ensures that a retainer ring 88, designed to seat in groove 80, prevents outboard bearing cone 24 from sliding out of hub 74, as will be described below, while not interfering with the fit or installation of hubcap 44.

Groove 80 may be formed with any sufficient width and depth to securely receive retainer ring 88. For example, groove 80 preferably is formed with a width of from about 0.020 inches to about 0.250 inches, and most preferably with a width of about 0.074 inches. In addition, groove 80 preferably is formed with a depth of from about 0.020 inches to about 0.250 inches, and most preferably with a depth of about 0.125 inches.

Retainer ring 88 is received in and seats in groove 80, and preferably is a flat, split-type ring. More particularly, ring 88 is formed with a split 90, so that during assembly of wheel end assembly 72, an installer can easily compress the ring against its bias to clear inner surface 78 of hub 74 to reach groove 80 from the outboard end of the hub. Once the installer aligns ring 88 with groove 80, the compression on the ring is released, enabling the ring to expand according to its bias in a radially outward direction so that its outer diameter 92 contacts a corresponding outer diameter surface 94 of the groove, and thus is securely mechanically seated in and engages the groove. For example, once inboard bearing cup 19 is pressed into the inboard end of hub 74, and outboard bearing cup 23 is pressed into the outboard end of the hub, inboard bearing cone 20 is inserted into the inboard end of the hub, main seal 52 is mounted on the inboard end of the hub, outboard bearing cone 24 is inserted into the outboard end of the hub, and the installer inserts retainer ring 88 into groove 80. Flub 74 with bearings 18, 22, main seal 52 and retainer ring 88 then is mounted on axle spindle 14.

Retainer ring 88 is formed with an inner diameter 96 of a dimension that is sufficient to ensure that the ring protrudes radially inwardly from groove 80 far enough to contact and retain a radially outward edge 84 of roller 64 of outboard bearing cone 24 when the roller is at its minimum projected diameter. More particularly, inner ring 66 of outboard bearing cone 24 is formed with a tapered contact surface 98 for roller 64, which includes sufficient contact area for the roller to shift or move slightly based on load conditions. Because contact surface 98 is tapered, when roller 64 shifts or moves on the contact surface, radially outward edge 84 of the roller moves radially inwardly or outwardly, as the case may be. As a result, inner diameter 96 of retainer ring 88 is of a sufficient dimension to contact radially outward edge 84 of roller 64 at its radially inward limit, which is referred to as the minimum projected diameter of the roller. Because roller 64, inner ring 66 and cage 67 of outboard bearing cone 24 are assembled as an integral unit, it is only necessary for retainer ring 88 to contact radially outward edge 84 of roller 64 at its minimum projected diameter to thereby secure and retain the entire outboard bearing cone.

Inner diameter 96 of retainer ring 88 is also larger than the outer diameter of nut 36 and any inner washer 34 (FIG. 1) of axle spindle nut assembly 32. This structure ensures that retainer ring 88 remains separate from spindle nut assembly 32, and does not interfere with installation of the spindle nut assembly onto axle spindle 14. As a result, during reassembly of wheel end assembly 72, if outboard bearing cone 24 has to be positioned more closely to outboard bearing cup 23, a technician is able to properly position the outboard bearing cone prior to installation of axle spindle nut assembly, which minimizes the possibility that the bearing cone may bind during tightening of the axle spindle nut assembly. By way of example, retainer ring 88 preferably is formed with an inner diameter 96 of from about 4.435 inches to about 6.000 inches, and most preferably about 5.375 inches. Of course, the size of inner diameter 96 depends on the diameter of outboard bearing 22. In addition, retainer ring preferably is formed with an outer diameter 92 of about 6.125 inches.

In this manner, retainer ring 88 is able to retain the relative position of cone 24 of outboard bearing 22 in hub 30 during servicing of brake rotor 58 or of components of wheel end assembly 12. As described above, retainer ring 88 is easy to install on hub 74. The use of retainer ring 88 and of groove 80, which may be formed in hub 74 during other machining operations for the hub, enables bearing retainer 70 to be simple in construction and cost-effective. Moreover, the split-type construction of retainer ring 88 enables the ring to be easily removable from groove 80 for servicing of bearings 18, 22 and/or hub 74, and to be re-usable.

By preventing outboard bearing cone 24 from shifting or moving out of hub 74, bearing retainer 70 prevents wheel end assembly 72 from being exposed to contaminants during servicing, thereby optimizing the life of bearings 18, 22. In addition, by preventing such movement of outboard bearing cone 24 during disassembly or reassembly of wheel end assembly 72, bearing retainer 70 reduces the possibility of tipping or shifting of hub 74, which in turn reduces the possibility of damage to components of the wheel end assembly, such as main seal 52. The prevention of excessive movement of outboard bearing cone 24 by bearing retainer 70 also enables an installer to focus on proper installation of axle spindle nut assembly 32 to optimize the life of bearings 18, 22, and removes the need for an installer to rebuild or reposition components of wheel end assembly 72.

Furthermore, bearing retainer 70 of the present invention is separate from axle spindle nut assembly 32 and instead is incorporated into hub 74, in contrast to known retainers of the prior art. By being separate from axle spindle nut assembly 32, bearing retainer 70 prevents movement of outboard bearing cone 24 when the spindle nut assembly is removed from the axle spindle. In addition, as a discrete component from spindle nut assembly 32, bearing retainer 70 enables a technician to properly position outboard bearing cone 24 before reinstallation and tightening of the spindle nut assembly after servicing of wheel end assembly 72, which reduces the possibility that the bearing cone may bind and become damaged when the spindle nut assembly is tightened.

As a result, the use of bearing retainer 70 of the present invention desirably minimizes the time and cost associated with the servicing of wheel end assembly 72 and/or components that are attached to the wheel end assembly.

The present invention also includes a method for forming a bearing retainer that includes forming a groove in a hub and seating a retainer ring in the groove to prevent excessive movement of the cone of the outboard bearing. The present invention also includes a method for servicing and/or assembling a wheel end assembly and/or components attached to the wheel end assembly using a bearing retainer that includes seating a retainer ring in a groove formed in the hub to prevent excessive movement of the cone of the outboard bearing. Each method includes steps in accordance with the description that is presented above and shown in FIGS. 3-5.

It is to be understood that other sizes, shapes, forms and configurations for retainer ring 88 may be employed, without affecting the concept or operation of the invention. It is also to be understood that retainer ring 88 may be formed of any suitable material, such as metals, alloys, plastics, elastomers, ceramics, composites, and/or combinations thereof, without affecting the concept or operation of the invention. It is to be further understood that the present invention finds application in all types of axle spindles and wheel end assemblies known to those skilled in the art, including other types of axle spindles and wheel end assemblies than those shown and described herein and known to those skilled in the art, without affecting the concept or operation of the invention.

Accordingly, the improved bearing retainer for heavy-duty vehicle wheel end assembly is simplified, provides an effective, safe, inexpensive, and efficient structure which achieves all the enumerated objectives, provides for eliminating difficulties encountered with prior art bearing retainers for heavy-duty vehicle wheel end assemblies, and solves problems and obtains new results in the art.

In the foregoing description, certain terms have been used for brevity, clarity and understanding; but no unnecessary limitations are to be implied therefrom beyond the requirements of the prior art, because such terms are used for descriptive purposes and are intended to be broadly construed. Moreover, the present invention has been described with reference to exemplary embodiments. It shall be understood that this illustration is by way of example and not by way of limitation, as the scope of the invention is not limited to the exact details shown or described. Potential modifications and alterations will occur to others upon a reading and understanding of this disclosure, and it is understood that the invention includes all such modifications and alterations and equivalents thereof.

Having now described the features, discoveries and principles of the invention, the manner in which the improved bearing retainer for heavy-duty vehicle wheel end assembly is constructed, arranged and used, the characteristics of the construction and arrangement, and the advantageous, new and useful results obtained; the new and useful structures, devices, elements, arrangements, parts and combinations are set forth in the appended claims.

1. A bearing retainer for a heavy-duty vehicle wheel end assembly, said wheel end assembly including an inboard tapered roller bearing immovably mounted on an axle spindle, an outboard tapered roller bearing immovably mounted on said axle spindle outboardly of said inboard bearing, and a wheel hub rotatably mounted on said inboard and outboard bearings, said bearing retainer comprising:
a circumferentially-extending groove formed in an inner surface of said wheel hub adjacent an outboard surface of the wheel hub; and
a retainer ring disposed in said groove, said retainer ring being formed with an inner diameter sufficient to enable the retainer ring to contact a radially outward edge of a roller of a cone of said outboard bearing when said roller is at its minimum projected diameter, said retainer ring inner diameter being larger than an outer diameter of an axle spindle nut assembly, whereby said retainer ring retains the position of said outboard bearing cone in said wheel hub during servicing of components of said wheel end assembly.

2. The bearing retainer for a heavy-duty vehicle wheel end assembly of claim 1, wherein said groove is formed in said inner surface of said wheel hub outboardly of an outboard surface of said roller of said outboard bearing cone, and inboardly of an inboard-most surface of a hubcap.

3. The bearing retainer for a heavy-duty vehicle wheel end assembly claim 1, wherein said retainer ring is a flat split ring.

4. The bearing retainer for a heavy-duty vehicle wheel end assembly of claim 1, wherein said groove is formed with a width of from about 0.020 inches to about 0.250 inches.

5. The bearing retainer for a heavy-duty vehicle wheel end assembly claim 4, wherein said groove is formed with a width of about 0.074 inches.

6. The bearing retainer for a heavy-duty vehicle wheel end assembly of claim 1, wherein said groove is formed with a depth of from about 0.020 inches to about 0.250 inches.

7. The bearing retainer for a heavy-duty vehicle wheel end assembly claim 6, wherein said groove is formed with a depth of about 0.125 inches.

8. The bearing retainer for a heavy-duty vehicle wheel end assembly of claim 1, wherein said retainer ring is formed with an inner diameter of from about 4.435 inches to about 6.000 inches.

9. The bearing retainer for a heavy-duty vehicle wheel end assembly claim 8, wherein said retainer ring is formed with an inner diameter of about 5.375 inches.

10. The bearing retainer for a heavy-duty vehicle wheel end assembly claim 1, wherein said retainer ring is formed with an outer diameter of about 6.125 inches.

11. A method of assembling a heavy-duty vehicle wheel end assembly including a bearing retainer, said method comprising the steps of:
providing an inboard tapered roller bearing;
providing a wheel hub, said wheel hub including a circumferentially-extending groove formed in an inner surface of the wheel hub adjacent an outboard surface of said wheel hub;
pressing a cup of said tapered inboard roller bearing into an inboard end of said wheel hub;
providing an outboard tapered roller bearing;
pressing a cup of said tapered outboard roller hearing into an outboard end of said wheel hub;
inserting a cone of said inboard bearing into said inboard end of said wheel hub;
inserting a cone of said outboard bearing into said outboard end of said wheel hub;
providing a retainer ring;
compressing said retainer ring to clear said inner surface of said wheel hub;
inserting said retainer ring into an inner diameter of said wheel hub;
releasing said compression of said retainer ring when the retainer ring is in alignment with said groove, whereby said retainer ring is diposed in the groove, and the retainer ring is formed with an inner diameter sufficient to enable said retainer ring to contact a radially outward edge of a roller of said outboard bearing cone when said roller is at its minimum projected diameter; and
mounting said wheel hub on an axle spindle, whereby said retainer ring retains the position of said outboard bearing cone in the wheel hub during servicing of components of said wheel end assembly.

12. The method of assembling a heavy-duty vehicle wheel end assembly including a bearing retainer of claim 11, wherein the step of inserting said retainer ring into an inner diameter of said wheel hub is performed from an outboard end of the wheel hub.

13. The method of assembling a heavy-duty vehicle wheel end assembly including a bearing retainer of claim 11, further comprising the step of mounting a main seal on said inboard end of said wheel hub.

14. The method of assembling a heavy-duty vehicle wheel end assembly including a bearing retainer of claim 11, wherein said retainer ring inner diameter is larger than an outer diameter of an axle spindle nut assembly.

15. The method of assembling a heavy-duty vehicle wheel end assembly including a bearing retainer of claim 11, wherein said groove is formed in said inner surface of said wheel hub outboardly of an outboard surface of said roller of said outboard bearing cone, and inboardly of an inboard-most surface of a hubcap.

16. The method of assembling a heavy-duty vehicle wheel end assembly including a bearing retainer of claim 11, wherein said retainer ring is a flat split ring.

17. The method of assembling a heavy-duty vehicle wheel end assembly including a bearing retainer of claim 11, wherein said groove is formed with a width of from about 0.020 inches to about 0.250 inches.

18. The method of assembling a heavy-duty vehicle wheel end assembly including a bearing retainer of claim 17, wherein said groove is formed with a width of about 0.074 inches.

19. The method of assembling a heavy-duty vehicle wheel end assembly including a bearing retainer of claim 11, wherein said groove is formed with a depth of from about 0.020 inches to about 0.250 inches.

20. The method of assembling a heavy-duty vehicle wheel end assembly including a bearing retainer of claim 19, wherein said groove is formed with a depth of about 0.125 inches.

21. The method of assembling a heavy-duty vehicle wheel end assembly including a bearing retainer of claim 11, wherein said retainer ring is formed with an inner diameter of from about 4.435 inches to about 6.000 inches.

22. The method of assembling a heavy-duty vehicle wheel end assembly including a bearing retainer of claim 11, wherein said retainer ring is formed with an inner diameter of about 5.375 inches.

23. The method of assembling a heavy-duty vehicle wheel end assembly including a bearing retainer of claim 11, wherein said retainer ring is formed with an outer diameter of about 6.125 inches.

24. The method of assembling a heavy-duty vehicle wheel end assembly including a bearing retainer of claim 11, wherein said retainer ring is a discrete component.

25. The bearing retainer for a heavy-duty vehicle wheel end assembly of claim 1, wherein said retainer ring is a discrete component.
